(19) United States
(12) Patent Application Publication
(10) Pub. No.: US 2008/0122192 A1
(43) Pub. Date: May 29, 2008

(54) BRICK, STONE AND TILE TRANSPORT AND DEPLOYMENT SYSTEM

(76) Inventor: Jeffrey C. Goodman, Yorkville, IL (US)

Correspondence Address: SHERIDAN ROSS PC, 1560 BROADWAY, SUITE 1200, DENVER, CO, 80202, US

(21) Appl. No.: 11/943,449

(22) Filed: Nov. 20, 2007

Related U.S. Application Data
(60) Provisional application No. 60/866,530, filed on Nov. 20, 2006.

(51) Int. Cl. B62B 3/00

(52) U.S. Cl. 280/47.371; 52/741.1

(57) ABSTRACT

A system for moving building materials, such as brick, stone, tile and similar items, at a work site including one or more mover dollies and one or more hand carts. The mover dollies generally comprise an elevated platform on which the building materials are positioned and wheels or other similar mechanisms by which the mover dolly may be repositioned at a work site. Building materials are loaded on the mover dolly and a hand cart is used to locate the mover dolly at the work site where skilled masons may remove the building materials in connection with building a structure. As building progresses, the mover dolly may be repositioned without unloading the building materials. When the supply of building materials on the mover dolly is depleted, the mover dolly is reloaded and returned to the work site using the hand cart.

### CROSS-REFERENCE TO RELATED APPLICATIONS

This patent application claims the benefit of U.S. Provisional Patent Application No. 60/866,530 filed on Nov. 20, 2006, the content of which is incorporated herein by reference in its entirety.

### FIELD OF THE INVENTION

The present invention relates to a system to facilitate the transport, placement and laying of brick, stone, tile and similar materials. For ease of reference, these will be collectively referenced herein as “building materials.”

### BACKGROUND OF THE INVENTION

Brick, stone and tile are popular building materials. Each can be laid to make a horizontal surface, such as a walkway, patio or driveway, or to make a vertical surface, such as a wall. Laying brick, stone or tile involves hard physical labor. One of the most laborious parts of brick, stone or tile laying is moving these building materials from the delivery point at a job site to the field of work where the building materials are put in place, e.g. laid by skilled persons. Skilled brick layers or masons lay the brick, stone or tile and create a finished product, whether that is a wall, patio, sidewalk, floor, building, chimney, fireplace, etc. and whether that requires vertical, horizontal or some other orientation of the materials. Manual laborers typically move the building materials and provide a constant supply of the building materials to the skilled masons as the work project progresses. In doing so, the supply of building materials for the skilled mason cannot simply be placed in one position, but must be supplied at different locations as the project progresses. Moreover, depending upon the particular job site, the field of work may be level, have an incline or grade associated with it, be topographically rugged or smooth, and therefore the movement of building materials about the job site can be complicated and made more difficult by the topology of the field of work.

Typically, bricks, stone, tile and/or similar building materials are delivered to a job site on large pallets moveable only by motorized lift trucks. Individually, bricks weigh between four to twelve pounds depending upon their configuration. Flagstone and other types of stone or pavers can weigh more. Boxes of tile can be equally heavy.

Conventional methods of moving bricks include brick carts and brick tongs. These methodologies are cumbersome. A brick cart pinches a strap of bricks. A strap is one or more rows of brick. A brick cart is hard to use and is very wide, making it difficult to fit through a narrow opening. In addition, a brick cart is designed to move primarily one type of brick, e.g. Holland-style pavers. Moreover, once bricks are moved using a brick cart, they need to be moved again by hand as the job progresses. Tongs are also problematic. Tongs are hard to load and unload. A user typically uses two tongs, one in each hand, to balance a load of bricks. The bricks are manually loaded or stacked in each set of tongs. Because of the physical labor involved, the laborer is limited to about 100 pounds per trip. Laborers tire quickly within a short time period and, relatively speaking, very few bricks are moved each trip. Invariably, accidents also occur with brick carts and tongs in which bricks are dropped creating a mess, perhaps braking one or more bricks and requiring the bricks to be manually moved yet another time.

Still further, the bricks, or stone or tile as the case may be, must be moved to the field of work from the delivery point, and they must also be deployed throughout the field of work in quantities sufficient for skilled persons to complete the particular brick laying job. Thus, there is not only a need to move the entire quantity of bricks, stone and/or tile needed for a job efficiently from the delivery point to the field of work, but there is also an ongoing requirement to continue to move an adequate supply of bricks, stone and/or tile within the field of work as the bricks, stone and/or tile is laid. For example, as a brick wall is being formed, the supply of bricks must be constantly moved laterally as the wall progresses, keeping pace with the brick layers. The same concept applies regardless of the structure, namely, the building materials must be transported from the delivery point to numerous positions dispersed at the field of work and likely moved again as the structure is built. Thus, it is possible that the same building materials may be moved multiple times before being laid. The fewer laborers that are available to move and deploy the bricks, the longer the task takes and the more physically tired the laborers become.

Accordingly, there is a need within the brick, stone and tile laying industry for a system that facilitates movement of large quantities of brick, stone, tile and similar building materials from a delivery area to the field of work where the building material is laid without requiring substantial labor or effort, or at least minimizing the amount of labor needed. In addition, there is a need within the art of brick, stone and/or tile laying to facilitate the supply and movement of building materials within the field of work to provide the mason with a ready supply of building materials without interruption, while minimizing the physical labor needed to provide the ready supply. Still further, there is a need to supply building materials to the field of work and be able to reposition previously deployed building materials to new locations within the field of work without significant effort and without lifting and/or carrying the building materials multiple times.

### SUMMARY OF THE INVENTION

The system generally comprises two types of components, a hand truck or hand cart for moving building materials from a delivery or drop off point to the field of work, and one or more mover or paver dollies to efficiently position an adequate supply of building materials within the field of work as a structure is built.

Typically, building materials, such as bricks and stone are delivered to a building site or work site loaded on palettes. The building materials must then be relocated within the field of work at the work site for skilled laborers, such as masons, to use in constructing a structure. In one embodiment of the present invention, one or more mover dollies are provided. A mover dolly is a platform, elevated off the ground by wheels or other similar mechanisms that permit the mover dolly to be repositioned while containing a load of building materials. A hand cart, comprising a vertical frame, one or more forwardly extending forks and at least a pair of wheels is also provided. The pair of forks is positioned underneath the platform of the mover dolly and by rotating the hand cart relative to its axle, the loaded mover dolly is lifted off the ground. The hand cart may then be used to transport the loaded mover dolly to a location at the work site where the supply of building materials are used by skilled masons to build a structure, such as a walkway, patio or wall.

Multiple mover dollies may be provided at the work site, fully loaded with building materials, depending upon the size of the structure being built. Because the mover dollies include wheels or similar modes of being able to move, as the masons use the building materials and construction progresses, the mover dolly may be repositioned to keep up with construction without having to physically carry the building materials to new locations. As the mover dollies are emptied building materials, physical laborers may carry the empty mover dollies back to the point where the building materials were delivered to the work site and reload the empty mover dollies. Using the hand carts, the reloaded mover dollies may be relocated to new locations at the work site.

In one embodiment of the present invention, the forks of the hand cart are designed to lift heavy loads of building materials, including up to 400 pounds or more. The hand cart may include two, three or more forks, depending upon the nature of the materials being used. Similarly, the length of the forks may be extended to accommodate mover dollies of different sizes, and the mover dollies may be made of different sizes to accommodate different types and weights of building materials. A backstop or screen may also be added to the vertical portion of the hand cart to prevent the building materials from falling off of the hand cart when a loaded mover dolly is being transported to the work site.

Through use of the present invention, fewer physical laborers are needed to supply building materials to skilled masons at a work site. This is because one person may transport a greater weight of materials in a single trip more quickly and with less effort than using presently available methods of moving building materials. The present invention also eliminates wasted physical effort by using mover dollies. As construction progresses, building materials do not need to be physically picked up and moved to new locations. Rather, the mover dollies may be moved along with the progression of the work, without having to unnecessarily lift the building materials.

### BRIEF DESCRIPTION OF THE DRAWINGS

FIG. 1 is a front plan view of one embodiment of the hand cart of the present invention.

FIG. 2 is a rear plan view of the embodiment of the hand cart of FIG. 1.

FIG. 3 is a side elevational view of the embodiment of the hand cart of FIG. 1.

FIG. 4 is a bottom plan view of the embodiment of the mover dolly of the present invention.

FIG. 5 is a front plan view of two mover dollies in a stacked arrangement, one turned 90 degrees relative to the other, and a rear plan view of the hand cart of FIG. 1, with the hand cart containing a load of bricks.

FIG. 6 is a side elevation view of one embodiment of the hand cart positioned to engage one embodiment of the mover dolly loaded with bricks.

FIG. 7 is a perspective view of a loaded mover dolly positioned to be lifted by a hand cart.

FIG. 8 illustrates one embodiment of the hand cart of the present invention rotated to lift a mover dolly containing a load of bricks.

### DETAILED DESCRIPTION OF THE INVENTION

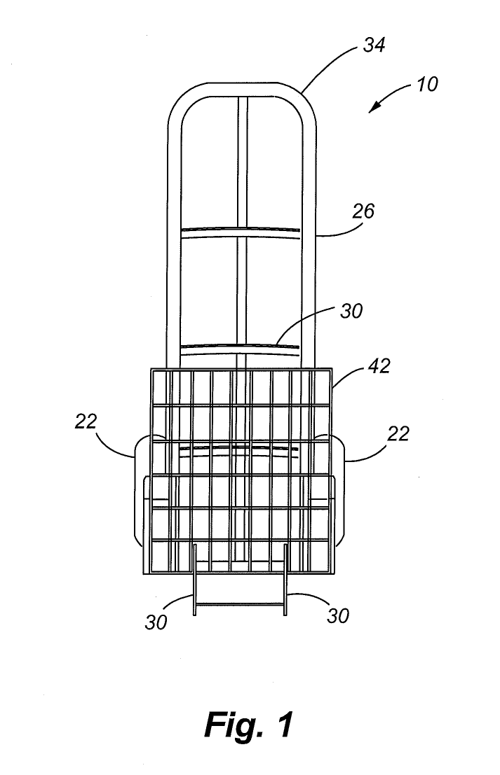

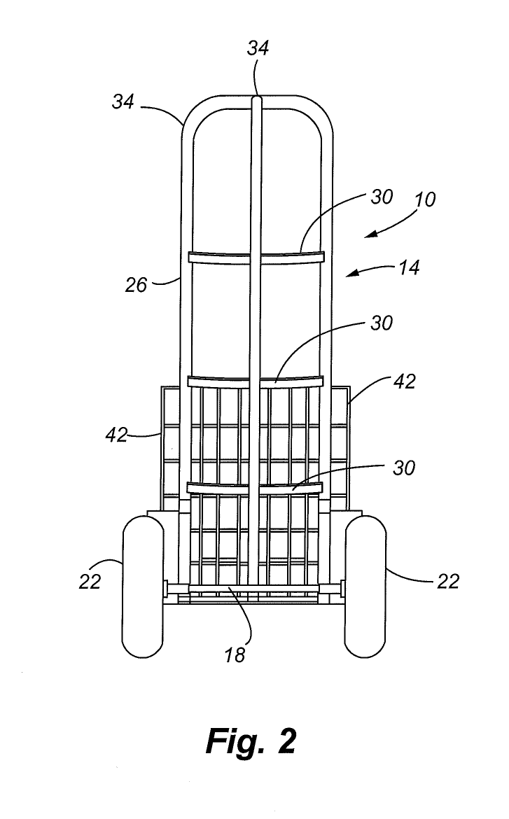

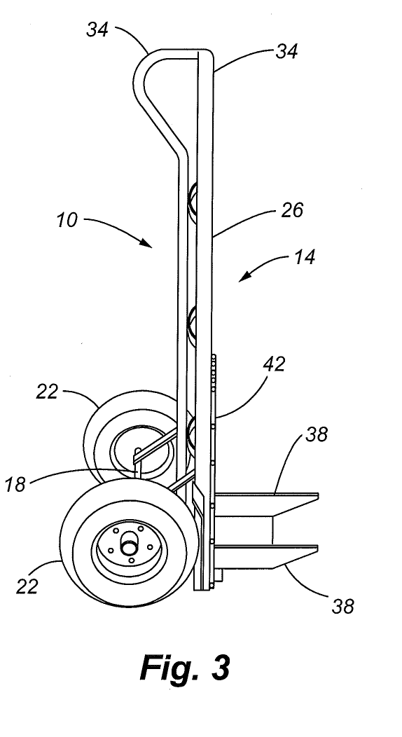

Referring to FIGS. 1-3, the hand cart 10 comprises a generally upright rigid metal frame 14. An axle 18 is mounted to the frame 14 and two wheels 22 are attached to the axle. Typically, the wheels are pneumatic and of a sufficiently large diameter to accommodate variations in the topology of the work area to facilitate movement of the hand cart from the delivery point to the field of work. The wheels on the hand truck may be, for example, 10, 12 or 14 inches in diameter. With specific reference to FIG. 3, the axle 18 may be moved laterally toward or away from the frame 14. The farther away the axle is positioned from the cart and the load of building materials on the cart, the harder it is for a laborer to rotate the cart about the axle and lift the load. Also, the farther the axle is positioned away from the frame, the higher the building materials will be relative to the ground, which may make movement of a loaded hand cart difficult, for example up stairs or over uneven topology. Conversely, the closer the axle is to the frame the easier it is to rotate the frame and lift the load, but the closer the load is to the ground. A small clearance with the ground may make transport of the load more difficult. Also, as the axle is moved closer to the frame, the wheels may need to be smaller so they do not interfere with the frame or the length of the axle extended in order to position the wheels outside the frame to similarly avoid interference with the frame.

The rigid frame 14 includes an upright portion 26 that may be constructed of solid or tubular metal, depending upon the desired strength and the weight of the building materials to be moved. Cross members 30 may extend across the frame to add rigidity and strength. Handles 34 may be positioned at the top portion of the frame 14 for use by an operator. The handles 34 on the hand cart 10 may be a continuous loop, dual loops, t-handles or rotating grip handles. Metal forks 38 are affixed to the upright frame portion 26 proximate the wheels 22 and extend outwardly from the frame 14 approximately perpendicular to the frame. In one embodiment, there are two separate forks 38 spaced apart from each other. There may be more forks or a single fork. As will be addressed in more detail below, the forks 38 are of sufficient thickness and shape to support the weight of a mover dolly containing a full cube of bricks or other building materials. In one embodiment, the forks are “L” shaped in cross-section. The length of the forks 38 is proportionate to the size of the mover dolly. The fork should at least be as long as one-half the width of the mover dolly.

In another embodiment, the two forks may be made from angled iron. This increases the weight they can support, permitting the mover dollies to transport large wall stone. Four hundred pounds or more of stone or load of bricks may be moved by the hand cart and mover platform configuration of the present invention. Of course, this may be made stronger as desired.

A mesh screen 42 or other type of blocking material (solid or mesh) may be added to the lower part of the frame to preclude building materials from falling through the frame when the hand cart 10 is transporting building materials to the field of work. The hand cart may be manually operated or motorized. A tool box or bag can be attached to the fork truck as a handy place for keeping necessary tools for use in the paving work.

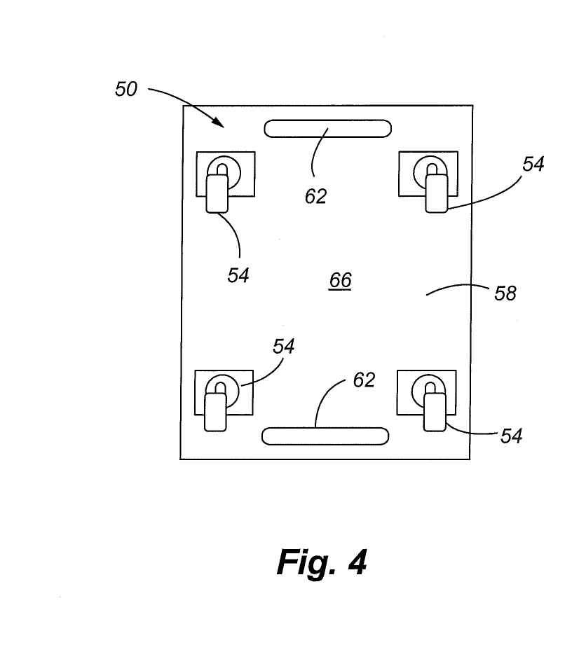

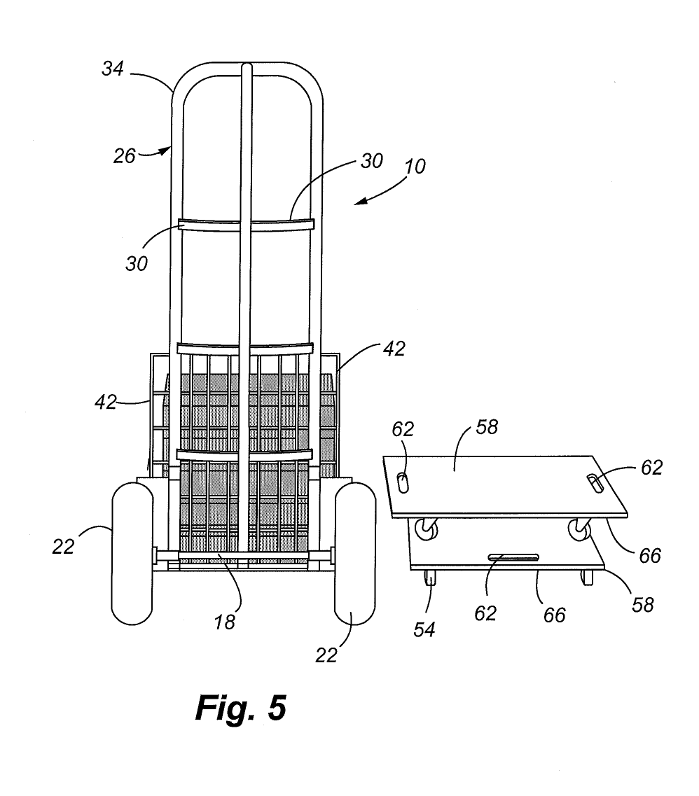

In the embodiment shown in FIGS. 4-7, the mover dolly 50 comprises four independent wheels 54 that are rotatably and pivotably connected to a platform 58 such that the platform can be moved across a surface in any direction as well as rotated. In another embodiment, the wheels may be fixed to an axle and not swivel relative to the platform. Three, four, five, six or more wheels may be used, or a track configuration such as a bull dozer may be used. The wheels 54 may be pneumatic or solid, wide, thin, tall or short. The wheels can also have brakes to prevent the platform from rolling, which is particularly desirable when the work surface is not level. The platform 58 may further include cutouts or handles 62 for a user to grasp the platform and move it from one position to another. One purpose of handles or finger grips is to prevent injury while moving a mover dolly loaded with building materials along the worksite. It is often possible to have fingers pinched between the platform and the wheels inadvertently. A second purpose is to facilitate movement of the mover dolly when it does not contain any building materials and may be carried by a laborer. For example, once a mason has removed the building materials from the mover dolly the empty mover dolly may be transported back to the supply of building materials to be reloaded and returned to the field of work. The laborer may easily carry the empty mover dolly using the handles. Different types of handles will be known by those skilled in the art. Additionally, a metal frame may be positioned along one or more sides of the platform to block access to the wheels and to avoid pinched fingers. A pull cord or chain could be used to move the mover dolly from one position to the next. In one embodiment the platform 50 has a rectangular shape with dimensions of approximately 18 inches by 18 inches. The platform may be larger, including 19 inches by 24 inches, or smaller depending upon the building materials being moved. Larger dimensions allow for the inclusion of handles, while still having sufficient surface area for stacking of building materials. In addition, brick, stone, tile and similar building materials come in varying sizes. Therefore, it will be appreciated by those skilled in the art that the size and dimension of the platform can vary depending upon the particular type of building material being installed. The corners of the platform can be square, rounded or angled, such as 45 degrees.

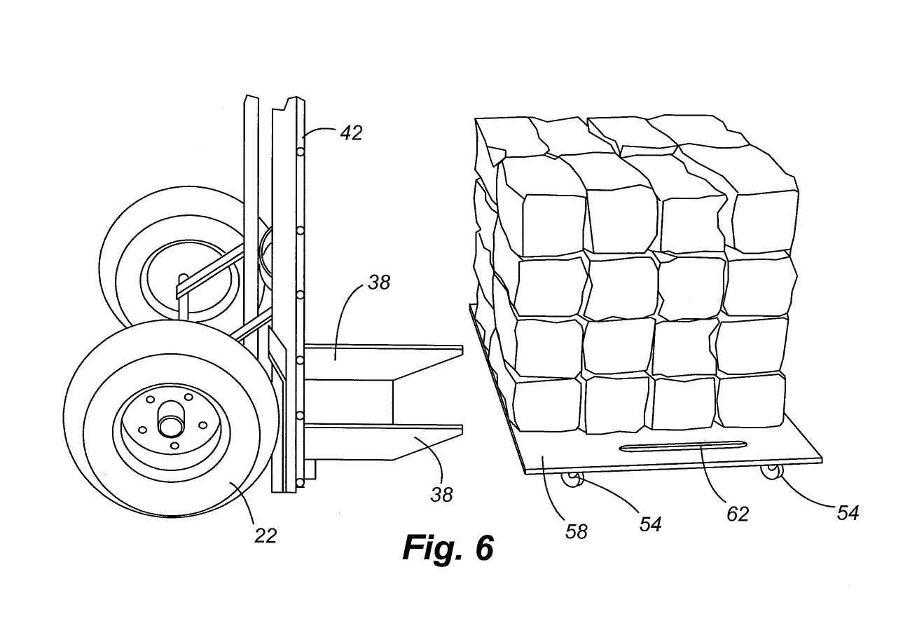

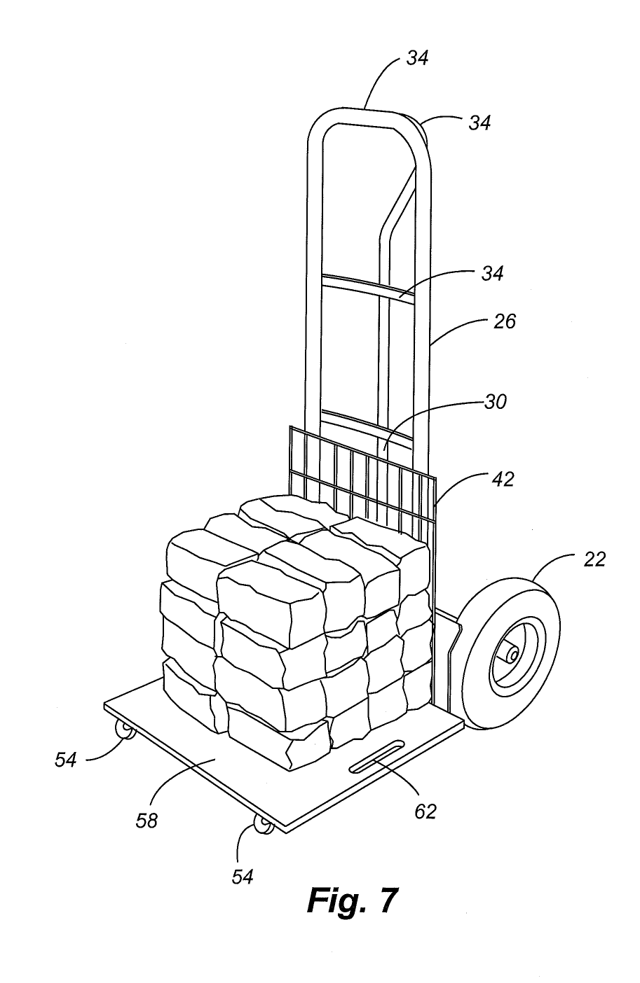

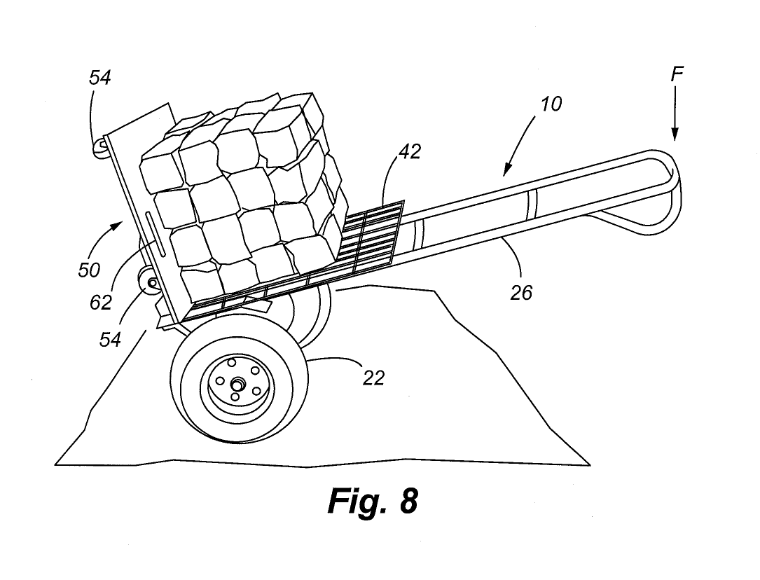

In operation, a load of building materials will be delivered to a job site. The building materials will typically be delivered on large pallets. These pallets are too large to be moved around the work site unless the work site is large enough to accommodate a full-size lift truck, which is not typical in residential or small commercial environments. One or more mover dollies are then positioned proximate the pallets of building materials and the building materials are manually stacked in cubes on the mover dollies. (See, FIGS. 6, 7.) In the case of bricks, tile and other symmetrically shaped building materials, the building materials are typically loaded onto the platform in a cube configuration which holds the building materials in place on the mover platform and on the hand cart. A mover dolly may easily hold 300 pounds or more of bricks arranged in a cube shape. This is a much greater number than can be moved with a brick strap or tongs. A hand truck 10 is then placed proximate the mover dolly and the forks 38 are inserted underneath the platform of the mover dolly. With reference to FIG. 6, the vertical height V of the forks is less than the space between the bottom surface 66 of the mover dolly and the ground. Thus, forks 38 of the hand cart may be slid underneath the mover dolly 50. (See, FIG. 7.) A user may then place his foot against the axle 18 of the hand cart and pull backwardly and downwardly on the handles 34 to pivot the hand cart about the axle 18 and lift the full load of building materials mounted on the mover dolly off the ground. A portion of the building materials will then rest against the screen or shield 42 at the lower end of the frame portion 14. As shown in FIG. 8, a force F must then be maintained on the handle 34 to keep the load of building materials in a position to allow movement of the hand cart 14. This force F can be made relatively small due to the geometry of the cart, making it relatively easy to transport the load of materials at a job site. The hand cart may then be easily moved by one person to a desired area in the field of work.

Multiple fully loaded mover dollies may be positioned strategically about the work site giving skilled masons access to a sufficient quantity of building materials as they construct the desired structure. In addition, the supply of building materials can be accomplished with individual loads being larger than a laborer could physically carry using conventional carrying techniques, with little physical exertion by the laborer. This allows fewer laborers to handle supplying building materials at a work site because they are less tired.

Importantly, because there are wheels on the mover dolly, the mason may easily roll the mover dolly along with him or her as the structure is built and the supply of building materials is used. Thus, there is no need for further lifting and moving of building materials along the structure site as construction progresses. Once a loaded mover dolly is placed in the field of work, the mason may easily move the mover dolly and load of building materials with him or her as the construction progresses simply by rolling it along the ground. This eliminates the need to pick up and carry the bricks from one location to another at the work site as tasks are completed.

The present invention reduces the amount of times individual building materials are touched to only twice—once to load the building materials onto a mover dolly at the original delivery site and once as the mason lays them in place on the structure being built. The present invention simplifies the labor involved for moving of the building materials. The person moving the building materials does not realize the weight of the building materials which rests on the axle of the hand cart and does not manually carry the load. After positioning a mover dolly containing a load of building materials at the work site, the wheeled platform may be readily moved as the mason sets the building material into place. The mason may also lean or sit on the cube of bricks to propel the mover dolly along with the worker and reduce the strain on the mason's back.

The present invention permits a stockpile of building materials to be positioned ahead of the mason(s), so an unlimited number of dollies can be utilized.

The present invention provides advantages over the prior art in that the laborers do not carry the weight of the building materials, the tool does. The building material remains in a mobilized state on a mover dolly which can be easily moved along with the workers as the job progresses. Again, no additional lifting is required. It reduces injury by reducing strain on back and shoulders. This results in a more efficient and productive work force, which increases productivity and profits.

What is claimed is:

1. A system for moving building materials to an area where the building material is formed into a structure, comprising:
a mover dolly comprising a platform having an upper surface and a lower surface, and a plurality of wheels disposed on the lower surface; and,
a hand cart comprising a substantially upright frame, at least one support member extending outwardly from said frame, and a plurality of wheels connected to said frame for rolling the hand cart from a first location to a second location;
wherein a load of building materials are placed on the upper surface of the mover dolly, the at least one support member is positioned underneath the platform of the mover dolly, the frame of the hand cart is moved to lift the platform off the ground and the hand cart containing the mover dolly loaded with building materials is moved to a different location.

2. The system of claim 1, wherein the frame of the hand cart includes a screen to hold the building materials on the platform of the mover dolly as it is moved.

3. The system of claim 1, wherein the mover dolly includes handles.

4. The system of claim 1, wherein the hand cart comprises at least one handle.

5. The system of claim 1, further comprising multiple mover dollies.

6. The system of claim 5, further comprising multiple hand carts.

7. The system of claim 1, wherein the building materials comprise one or more of brick, stone, tile and/or rock.

8. A method of positioning building materials at a work site, comprising:
a. Positioning building materials on a first mover dolly, the mover dolly including means to move from one location to another;
b. Using a hand cart, moving the first mover dolly to a first location at the work site;
c. Positioning building materials on a second mover dolly, the mover dolly including means to move from one location to another;
d. Using a hand cart, moving the second mover dolly to a second location at the work site.

9. The method of claim 8, further comprising unloading the building materials from the first mover dolly one at a time as part of building a structure, and moving the first mover dolly as the structure is built.

10. The method of claim 8, further comprising positioning building materials on a third mover dolly, the mover dolly including means to mover the third mover dolly from one location to another, and using a hand cart, moving the third mover dolly to a third location at the work site.

11. The method of claim 8, wherein the same hand cart is used to move the first and second mover dollies to the work site.

12. The method of claim 9, further comprising reloading the first mover dolly with building materials.

13. The method of claim 12, using a hand cart, moving the reloaded first mover dolly to the work site.

14. The method of claim 12, further comprising providing the first mover dolly with a handle and, prior to reloading the first mover dolly with building materials, carrying the mover dolly to a supply of building materials wherein it may be reloaded with building materials.
